(19) United States
(12) Patent Application Publication
(10) Pub. No.: US 2015/0046441 A1
(43) Pub. Date: Feb. 12, 2015

(54) RETURN OF ORTHOGONAL DIMENSIONS IN SEARCH TO ENCOURAGE USER EXPLORATION

(71) Applicant: Microsoft Corporation, Redmond, WA (US)

(72) Inventors: Deepak Vijaywargi, Sunnyvale, CA (US); Tianchi Ma, Sammamish, WA (US)

(73) Assignee: Microsoft Corporation, Redmond, WA (US)

(21) Appl. No.: 13/962,944

(22) Filed: Aug. 8, 2013

(51) Int. Cl. G06F 17/30

(52) U.S. Cl. CPC G06F 17/30864
USPC 707/731; 707/722

(57) ABSTRACT

Architecture that provides results and data which are alternative (“orthogonal”) to the original (or primary) query and encourage the user to engage with dimensions of information other than, but related to, the original query intent. The architecture computes the original intent of original search query, computes a category of the original query based on the original intent, computes a target document (result) of a domain based on the query intent, determines if orthogonal intent is desired, computes an alternative document result of the domain related to the intent, and presents content associated with the alternative document result.

### BACKGROUND

When a search engine processes a query, the traditional search engine index returns results related to the query. If the query is a website, such as {cnn}, the index finds the webpages having content about the news company CNN™, such as the company founder, geographical location, etc.

Search engines currently provide solutions for determining primary intent of the query and consider this criterion as task completion. For example, if the query is {cnn}, the computed query intent may be {cnn.com}—the website domain associated with {cnn}. Oftentimes, the task is not completed by simply navigating the user to the website domain, since the user may intend to conduct further exploration of content of interest not on the page to which the user was directed.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture addresses the aforementioned shortcomings by providing results and data which are alternative (“orthogonal”) to the original (or primary) query and encourage the user to engage with dimensions of information other than, but related to, the original query and original query intent.

The architecture computes the original intent of a search query, computes a category (or segment) of the query based on the intent, computes a target document result of a domain based on the query intent, determines if orthogonal intent is desired, and if so, computes an alternative document result of the domain related to the intent, and presents content/document associated with the alternative document result.

Thus, in one implementation, the architecture finds alternative search results for a domain, in the domain. Rather than returning results from other websites about the domain, if a classifier analyzes and computes the user query as navigational to the domain, the related content and topic results presented and related to the orthogonal intent are extracted from the domain. Alternatively, the architecture finds orthogonal results from other websites as well.

The architecture enables the capability to detect orthogonal dimensions to present. For example, for a query “hulu”—show the realtime trending content, personalized update on the content, etc. For a query “google”—show the popular topics in the web (personalized and anonymized). Triggering logic determines which queries have orthogonal intent. Content is ranked for selection and presentation based on the category and website profile.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates an alternative system that comprises the system of FIG. 1 and additional components.

FIG. 3 illustrates a backend system that facilitates the generation and presentation of orthogonal content in accordance with the disclosed architecture.

FIG. 4 illustrates an exemplary search engine results page that presents the alternative documents results as part of the other typically returned search results.

FIG. 5 illustrates an exemplary search engine results page that presents trending content as part of the other typically returned search results.

FIG. 6 illustrates an exemplary search engine results page that presents trending content for various domains of navigational segments.

FIG. 7 illustrates a method in accordance with the disclosed architecture.

FIG. 8 illustrates an alternative method in accordance with the disclosed architecture.

FIG. 9 illustrates a block diagram of a computing system that facilitates the return of orthogonal dimensions in search to encourage user exploration in accordance with the disclosed architecture.

### DETAILED DESCRIPTION

The disclosed architecture finds results on the website (the domain) when the query is treated as for the website (the domain). The user does not need to query the website in exact form; however, as long as the architecture classifier(s) analyzes and computes the user's query as navigational to the website domain (e.g., cnn.com), the related content and topics presented in the result page are obtained from the website (cnn.com).

The architecture detects orthogonal dimensions to present such as realtime (e.g., on the basis of hours) trending content, personalized update on the trending content, etc., and for queries that related to search engines, show the popular topics in the web (personalized and anonymized (made anonymous)). The architecture employs triggering logic to determine which queries have orthogonal intent, and provides the capability to rank content to present based on the segment (category) and a website profile.

The term “orthogonal” is intended to mean, based on query intent, showing results that are different and which give some degree of user satisfaction, yet navigating the user to a landing page (LP) that is different than the LP that would have been presented for the original query. Thus, the different landing page or (alternative result document) provided by the disclosed architecture improves on the satisfaction of the user. The time-to-success (the amount of time it takes to satisfy the user based on the intent) is much shorter.

The capability of finding results more useful to the user can be obtained by filtering results and even searching results based on data about the user, such as user preferences that may include user devices in use at particular times of the day (e.g., smartphone, laptop, tablet, etc.), user travel habits (e.g., local, on travel, between work places, buildings, etc.), user work habits (at different times of day, day of week, holidays), user browser history (e.g., websites visited more frequently than other websites, content viewed, content not viewed, click-through, time duration of content viewing (also called dwell), etc.).

For example, if the search query is youtube, the architecture can begin showing the top videos from youtube, the top music from youtube, the information about youtube, etc. Based on the content from the landing page it is desired to find content of more interest to the user to save the user time. The result page can be within the youtube website rather than the landing page of the returned result.

There can be alternative document results in other websites that satisfy the orthogonal intent. For example, the query intent of cnn is news, and the query intent of youtube is videos. By generating trending content in youtube and of other related content website pages as results, rather than the typical query landing page saves the user time and increases user satisfaction.

For performance purposes, a first step can be to determine if the query has an orthogonal intent. This can be obtained by monitoring user actions on a landing page, for example, to determine if the user is satisfied with that page. If the user actions on that page indicate navigation away from that page or away from content on the page, it is highly likely the user is exhibiting interest that does not align with the content shown on the page (i.e., interest that is orthogonal). Moreover, the time taken by the user to then obtain the desired page/content result can be identified. One or more classifiers can be employed to identify this user interactive/satisfaction behavior.

A next step can be categorization—to detect the category or segment (e.g., video, adult, news, sports, music, etc.) of the user query based on the orthogonal intent. There is offline data that can be used with the online data. The offline data and associated pipelines are described in greater detail herein below.

Once the architecture computes that orthogonal intent is indicated (by the query, domain, and user actions on a particular content category), another pipeline provide information. This offline pipeline runs continuously to generate, store and make available a list of domains and content to save time, using trending content, trending topics, etc. This pipeline determines the most popular items (e.g., topic, URLs (uniform resource locators), etc.) in the last x amount of time (e.g., hours, couple days, etc.). Thus, for certain domains, only the topics can be shown. For example, if the query is cnn, topics such as “building collapse in PA” and “Boston bombing” previously engaged by users can be presented. Accordingly, a click-through by the user does not actually take the user to that webpage, but results related to the particular event—not the domain.

With respect to URLs, the architecture obtains the metadata (e.g., timestamp of building collapse in PA when it started to happen, number of killed or injured, etc.). Another pipeline operates on a list of URLs for topics and more detailed information such as the statistics and summaries related to a URL itself, etc.

In order to develop a website profile, the architecture samples webpages from the domain. These pages are used for model training in terms of how the page template is changing.

Classifiers use backend data and other data to determine if the query has any relation to the intent. Browser logs and social data can be used, as well as the query itself and click-through data. Personally identifiable information (PII) data is removed so the user identity is anonymized.

Content can be ranked based on segment (category) and website profile. This is a relevance problem such that from a given segment and given domain, there may be have documents that appear to be relevant for this particular query—relevant in terms of trending popular or what the user may find interesting. Heuristics and ranking methods are applied to find the top content. For example, the volume of queries received in the past six hours, type of content (e.g., video, audio), and the correlation of this list (how many people are “tweeting” about it, posting on a social website, etc.) gives values that can be used to rank the documents and segments. News segments tend to have different profiling than video segments, etc. The website profile plays in to the role of understanding the kind of content, does the kind of content associated statistics, a multimedia element to it, etc.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

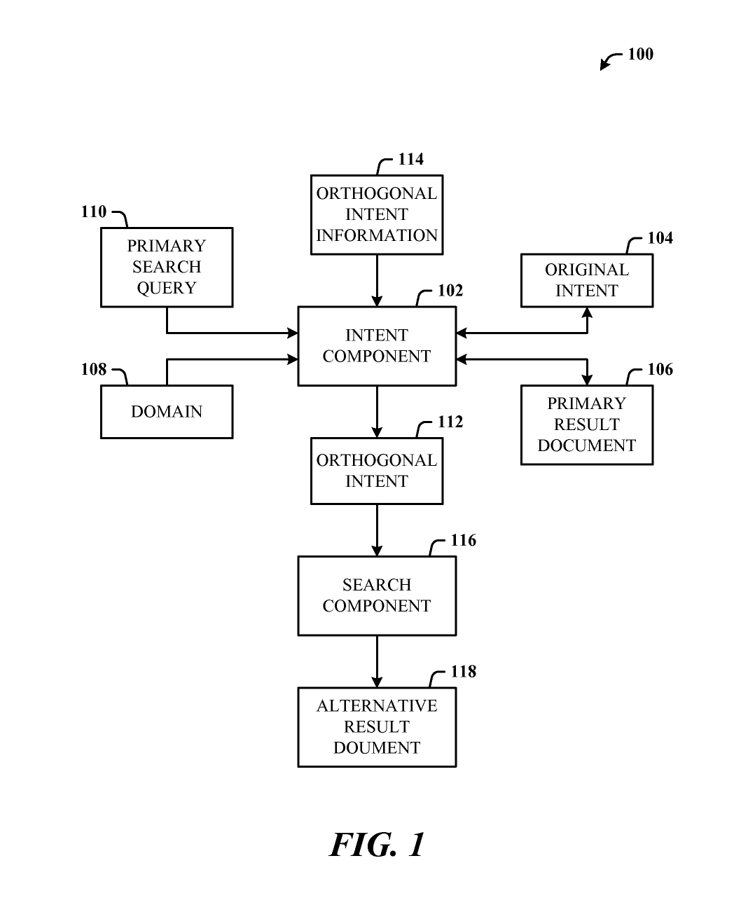

FIG. 1 illustrates a system 100 in accordance with the disclosed architecture. The system 100 can include an intent component 102 that computes original intent 104 and a primary result document 106 of a domain 108 of a primary search query 110, and identifies orthogonal intent 112 of the primary search query 110 based on orthogonal intent information 114.

A search component 116 (e.g., search engine) generates and returns an alternative result document 118 of at least one of the domain 108 or another domain for presentation (display in a search engine results page) based on the orthogonal intent 112. The alternative result document 118 relates to trending content of the domain 108 or other domains (e.g., the another domain). The orthogonal intent 112 is computed based on the orthogonal intent information 114 derived from analysis of user interaction with content of the domain 108.

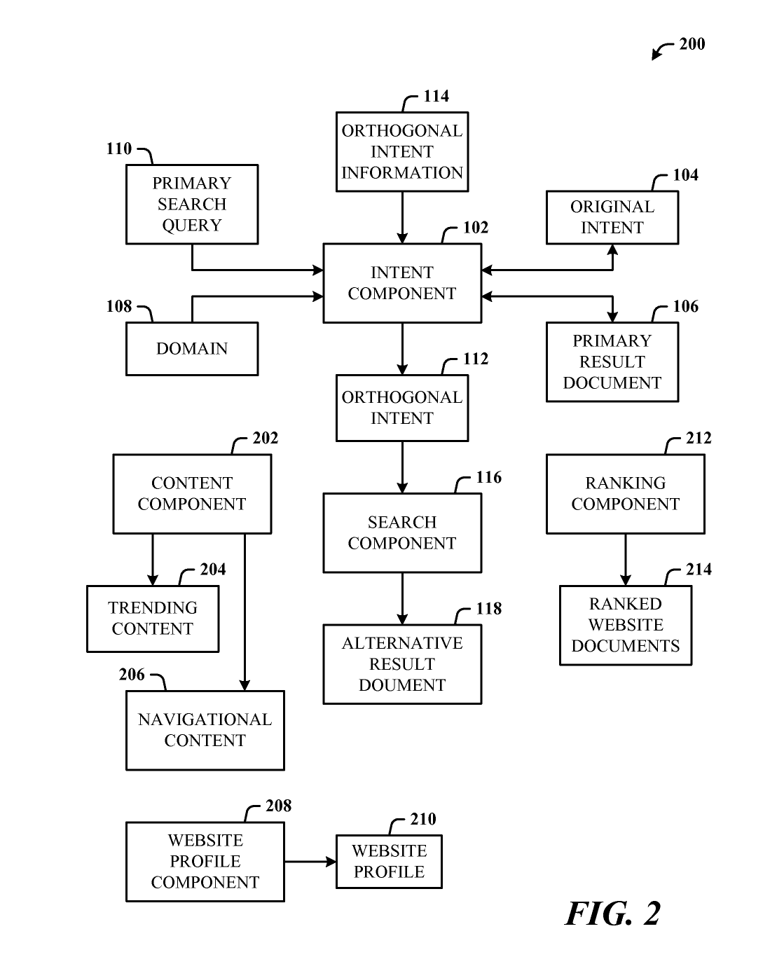

FIG. 2 illustrates an alternative system 200 that comprises the system 100 of FIG. 1 and additional components. The system 200 can further comprise a content component 202 that computes trending content 204 of the domain 108 based on trending topics, social data, and browser data. The content component 204 alternatively, or in combination therewith, computes navigational content 206 related to social data, search data, and trending topics.

The system 200 can further comprise a website profile component 208 that generates a website profile 210 based in part on classification of website user-accessed documents (webpages) and document content (e.g., advertisements, search results, etc.). The website profile component 208 periodically updates the website profile 210. The system 200 can further comprise a ranking component 212 that ranks website documents to output ranked website documents 214 based in part on the website profile and category of the original intent.

With respect to profiling, a predetermined list of websites can be created for profiling. In support thereof, data pipelines are utilized. A data pipeline runs on top of a browser logs collected. For each website, the pipeline selects data pages accessed by the browser users, together with the page content retrieved by joining the search engine index.

The website profile is computed based on the data pages. In operation, the data pages are sent individually (one-by-one) to a series of classifiers, which eventually return the page type. For example, for a celebrity news page from tmz.com, a domain classifier first categorizes the page as in a news segment. Thereafter, the page is sent to a news classifier, which returns the category of the news page. In this example, the page is classified as “Entertainment News”.

After all the data pages are classified, the classified results are clustered. If a significant number of pages in a website are clustered to be certain type (e.g., “Entertainment News” in the tmz example), the website is tagged (profiled) as this type. If multiple clusters exist at the same time for the website, the website can have more than one tag.

This set of one or more tags form the profile of the website. Using the website profile, the ranking of a webpage in that website can be increased or decreased to help decide whether to show the page. For example, the website tmz.com is classified as “Entertainment News”, while espn.com is classified as “Sports News”. If thereafter it needs to be determined how to rank a webpage of sports game news for tmz, the page ranking is decreased, while if for espn, the page ranking is increased.

The same rule can be applied to showing related topics. A trending topic is derived from a query. For a particular query, a classifier is applied to determine the query category. Then the website profile is matched to decide the website rank. To keep the profile up-to-date, the data pipeline can extract new data pages and re-train the website profile every predetermined x number of days (e.g., seven), and the pages selected are all accessed within the last x days.

The system 200 can further employ a privacy component (not shown) for authorized and secure handling of user information. The privacy component enables the user to opt-in and opt-out of tracking information as well as personal information. For example, the user can be provided with notice of the collection of personal information, and the opportunity to accept or deny consent to do so.

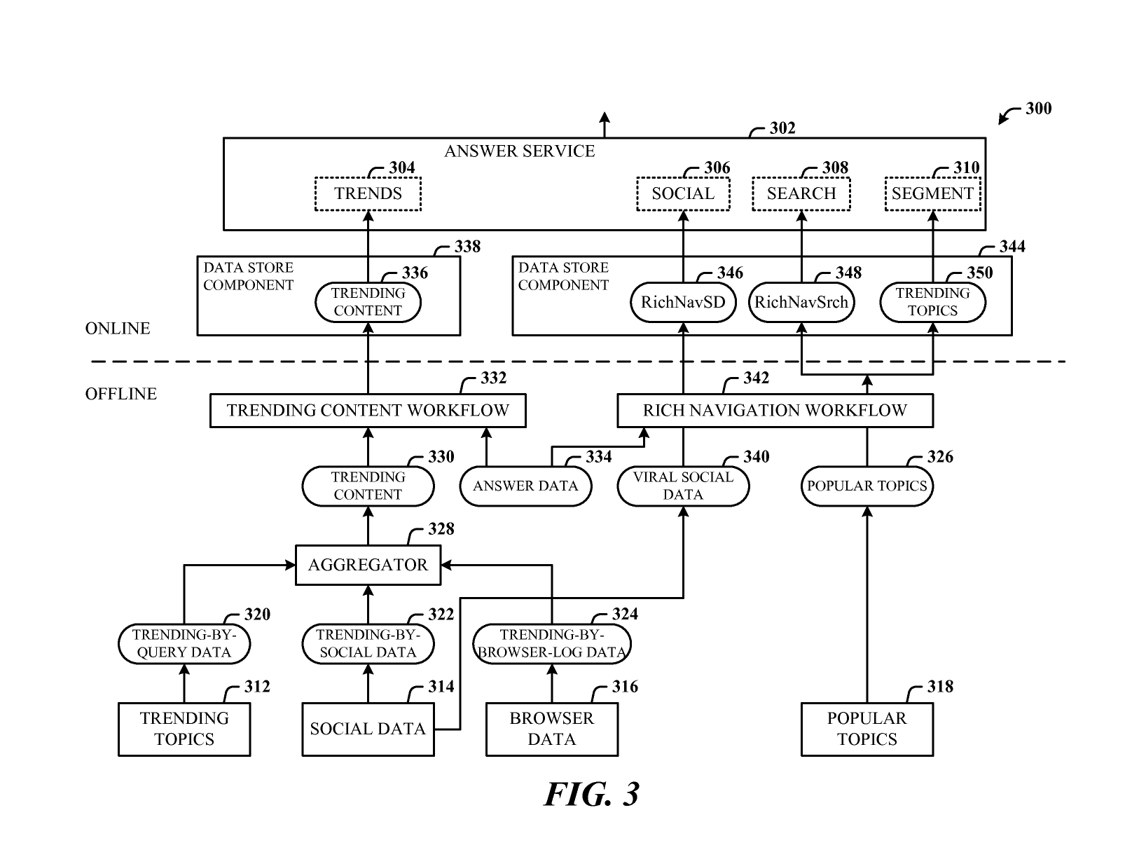

FIG. 3 illustrates a detailed backend system 300 that facilitates the generation and presentation of orthogonal content in accordance with the disclosed architecture. The system 300 is an answer service 302 that outputs content/documents/data related to trends 304, social 306 (networks), search 308 (engines), and segments 310 (or content categories such as news sources). For example, a trending topics pipeline 312, social data pipeline 314, browser data pipeline 316 and popular topics pipeline 318 provide the sources of information to the answer service 302.

The trending topics pipeline 312 monitors and obtains “spiking” queries (the most actively-occurring or popular queries that are being processed at a specific point or span of time). This can be obtained according to a predefined frequency (e.g., every fifteen minutes). Ranking and merging is then performed to find ranked topics. A search engine news index is then access and related pages are obtained to output a list of <topic, pages> tuples. The tuples are then grouped (clustered) by page domains and sorted by topic rank. The output of this operation is a list of <domain, list<topic, pages>> tuples. The output of the trending topics pipeline 312 is the trending-by-query data 320.

The social data pipeline 314 monitors and obtains “shared” (user-selected to share with another social network user) social network content. This can be obtained according to a predefined frequency (e.g., every fifteen minutes). This shared content can then be ranked according to the desired criteria, such as based on the history of social network “hits” (user-selection actions). The output of this operation is a ranked set of content. The ranked content is then grouped (clustered) by page domains and sorted by content rank. The output of the social data pipeline 314 is the trending-by-social data 322.

The browser data pipeline 316 produces trending-by-browser-log data 324. In operation, the browser data pipeline 316 accesses the browser logs for “hits” (website documents that were accessed) within a recent period of time. The hits are then aggregated and applied against processed browser logs to compare and calculate trends for sliding windows of time (e.g., hours or days) over specific time spans (e.g., days, etc.). The compare/calculate operation also includes previously processed browser logs to determine trends for the specific time spans. The trends from the calculate/compare process and a previous trending list are then merged into a new trending list. From the new trending list and the processed browser logs (from earlier), the number of hits over a time span are derived. This is then used to remove URLs (uniform resource locators) that are no longer trending, and generate the trending-by-browser-log data 324. The results of the removed URLs are then applied back to the previous trending list to update it for the merge process.

The browser data pipeline 316 also develops a content URI identifier model. From the browser data logs accessed early in the browser pipeline 316, a sample is randomly obtained on a per domain basis and used as a URL identifier training data. The URL identifier training data and previous training data are input to a URL identifier trainer, the output of which is the URL identifier model.

The popular topics pipeline 318 takes top editorial queries, applies the queries to a news answer (e.g., MSN™) and then filters out all queries having the news answer to output the popular topics 326, as based on the news source (e.g., MSN).

The trending-by-query data 320, trending-by-social data 322, and trending by-browser-log data 324 are processed through an aggregator 328 to output the trending content 330, which is then input to a trending content workflow 332 along with answer data 334. The offline answer data 334 includes a logo and description of the particular entity. An output of the trending content workflow 332, an offline process, is trending content 336 as input to an online data store component 338 (e.g., a key-value store) that enables the realtime fetching of stored data by the answer service 302 (e.g., Odyssey™) for trending content, an online process.

Similarly, on the rich navigation side (offline), viral social data 340 is obtained from the ranked content of the social data pipeline 314. The answer data 334, viral social data 340, and popular topics data 326 are then input to an offline rich navigation workflow 342, the output of which is to an online data store 344 (e.g., a key-value store) that enables the realtime fetching of stored data by the answer service 302 (e.g., Odyssey) for navigation data handling for rich navigation social data (RichNavSD) 346, rich navigation search data (RichNavSrch) 348, and trending topics 350. The viral social data 340 is processed through the rich navigation workflow 342 to the online data store component 344 as the rich navigation social data 346. The popular topics data 326 is processed through the offline rich navigation workflow 342 to the online component 344 as the rich navigation search data 348 and the trending topics 350.

The online content and document management components (338 and 344) provide access by the answering service 302 to the trending content 336, rich navigation social data 346, rich navigation search data 348, and trending topics 350, as correspond to the trends 304, social 306, search 308, and segments 310. As an example of a combination of trending data sources, top news can be derived from trending topics plus viral social data, and videos, from browser logs and viral social data.

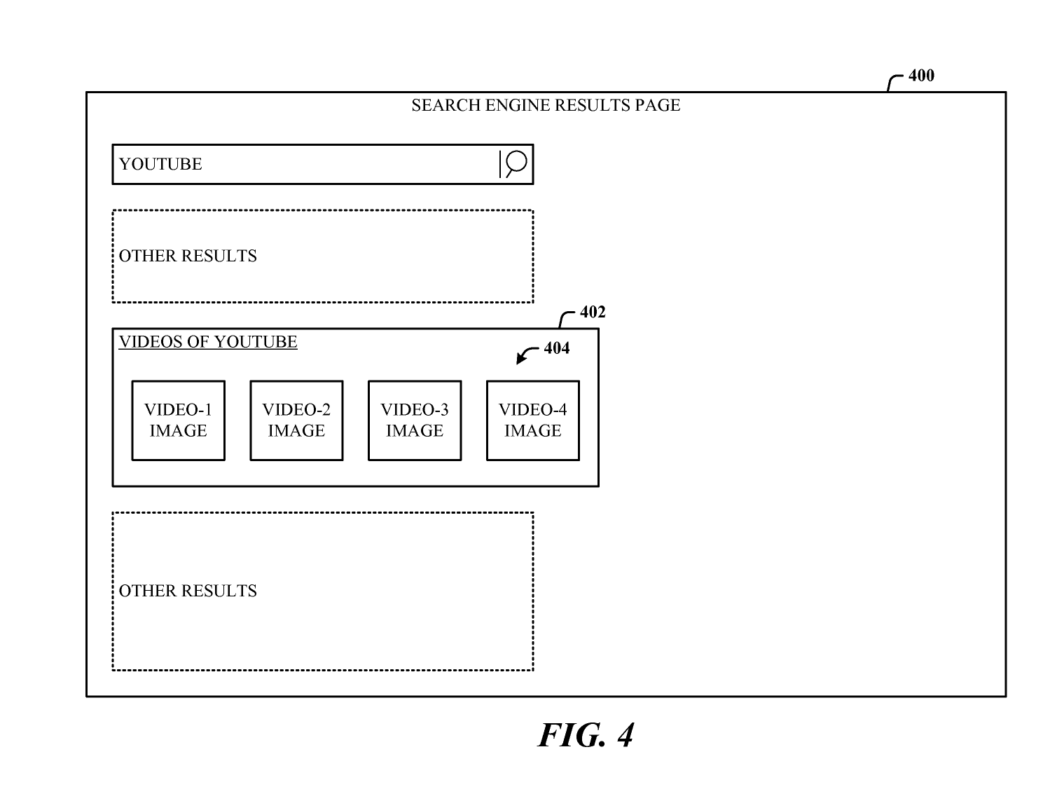

FIG. 4 illustrates an exemplary search engine results page 400 that presents the alternative documents results 402 as part of the other typically returned search results. In this example, the primary search query is youtube. The domain may be youtube.com, yet the document results 402 are videos 404 are the orthogonal dimension of the youtube.com website. This orthogonal intent is derived from the original intent of the user query. Here, four different videos related, but orthogonal to, the original intent of the query.

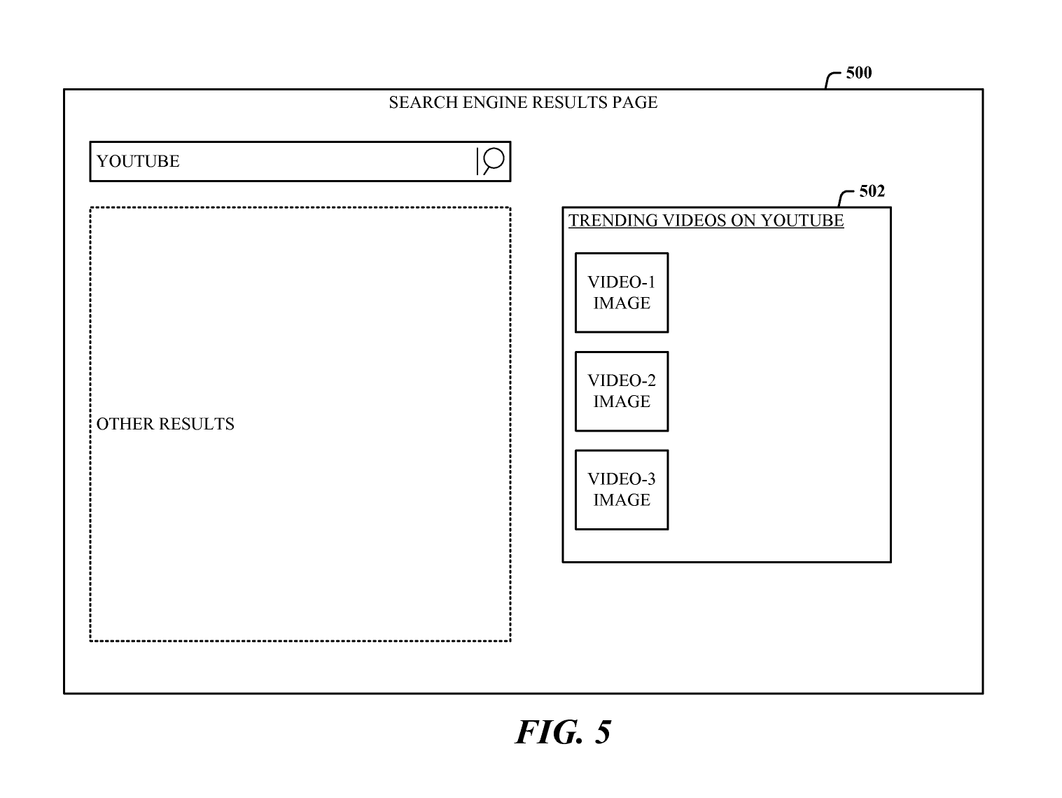

FIG. 5 illustrates an exemplary search engine results page 500 that presents trending content 502 as part of the other typically returned search results. In this example, the primary search query is youtube. In response, the trending content 502 can be trending videos and news articles generated based on search logs, social data and browser logs. The trending content 502 can be configured to automatically update every few hours (e.g., two to three hours).

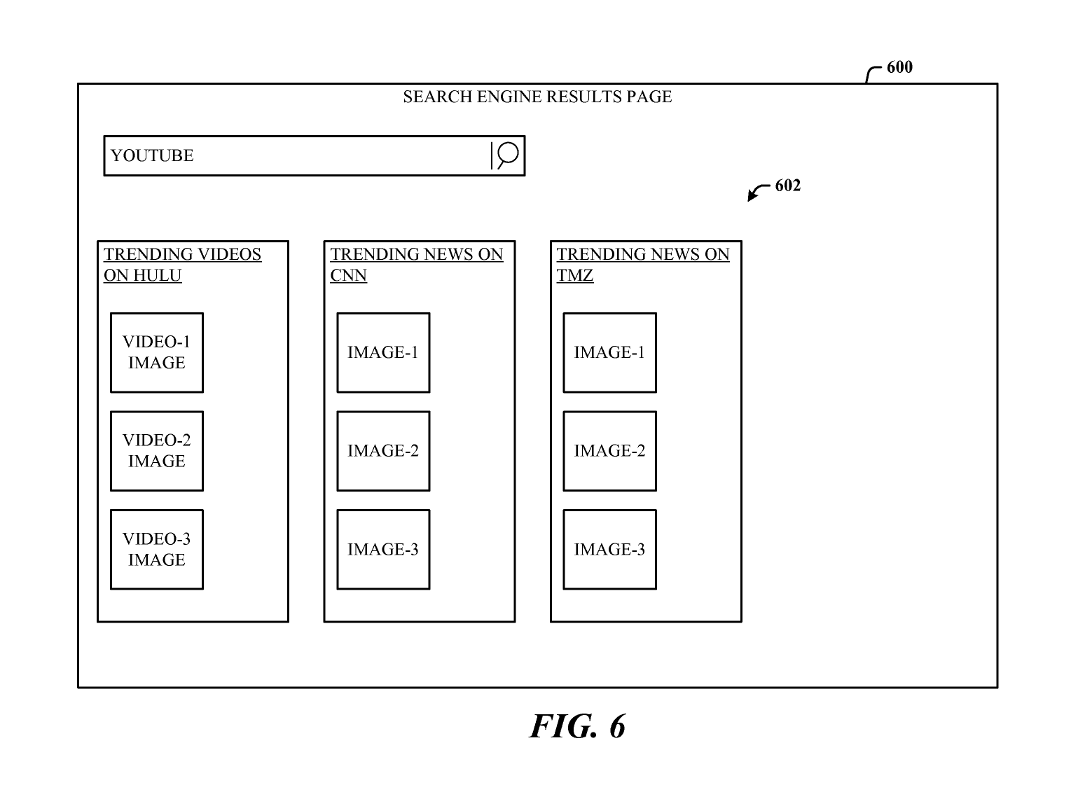

FIG. 6 illustrates an exemplary search engine results page 600 that presents trending content 602 for various domains of navigational segments. In this example, the primary search query is youtube. In response, the trending content 602 can be returned as trending videos and news articles generated based on search logs, social data and browser logs. The trending content 602 can be configured to automatically update every few hours (e.g., two to three hours).

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

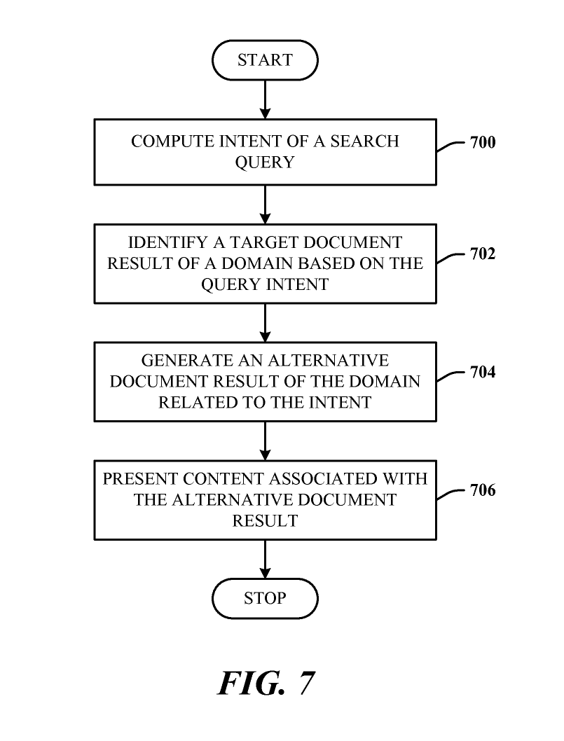

FIG. 7 illustrates a method in accordance with the disclosed architecture. At 700, intent of a search query is computed. The original intent is derived for the primary query. At 702, a target document result of a domain is identified based on the query intent. For example, the target document result can be a link to the domain home page. At 704, an alternative document result of the domain related to the intent is generated. The orthogonal intent is computed and based on this intent, the alternative document result is then returned. At 706, content associated with the alternative document result is presented.

The method can further comprise computing a category of the query based on the intent. The category can be news, sports, weather, etc. The method can further comprise computing the content based on personalized data. The personalized data is the user preferences that enabled filtering of the results to obtain content of interest to the user. The method can further comprise computing the content based on anonymized data. The amount of personalized data is reduced but some can still be used, as well as data derived from other users to obtain content of interest to the user.

The method can further comprise creating a website profile on which to base the alternative document result. The backend system can generate and retain website profiles for a large number of websites. As previously indicated, a given website profiles can include multiple tags such as a news tag, a sports tag, etc.

The method can further comprise selecting the content to present based on content ranked according to category and website profile information. The ranking can be made based on user selection history, for example, as obtained from browser logs, search engines logs, and so on.

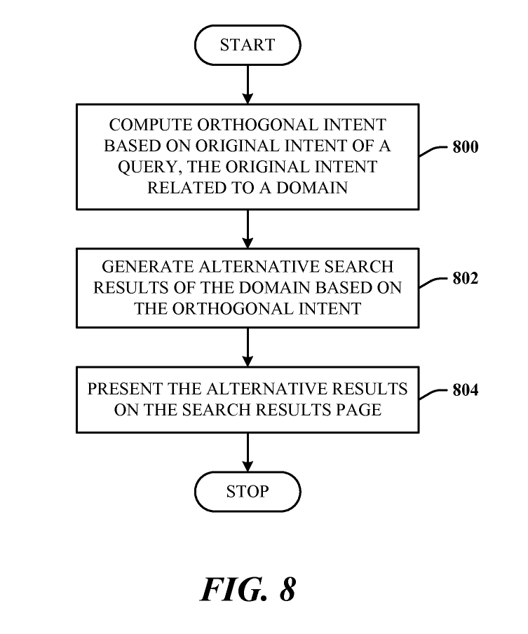

FIG. 8 illustrates an alternative method in accordance with the disclosed architecture. At 800, orthogonal intent is computed based on original intent of a query, the original intent related to a domain. At 802, alternative search results of the domain are generated based on the orthogonal intent. At 804, the alternative results are presented on the search results page.

The method on the computer-readable medium can further comprise computing the content based on personalized data or anonymized data. The method on the computer-readable medium can further comprise selecting the content to be presented based on content ranked according to category and website profile information. The method on the computer-readable medium can further comprise computing the orthogonal intent based on user interaction with content of a landing page. The method on the computer-readable medium can further comprise computing the alternative search results based on offline pipelines for generating trending topics, trending content, search content, and social network data. The method on the computer-readable medium can further comprise presenting the alternative results as in a listing of the search results.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in a volatile or a non-volatile storage medium), a module, a thread of execution, and/or a program.

By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

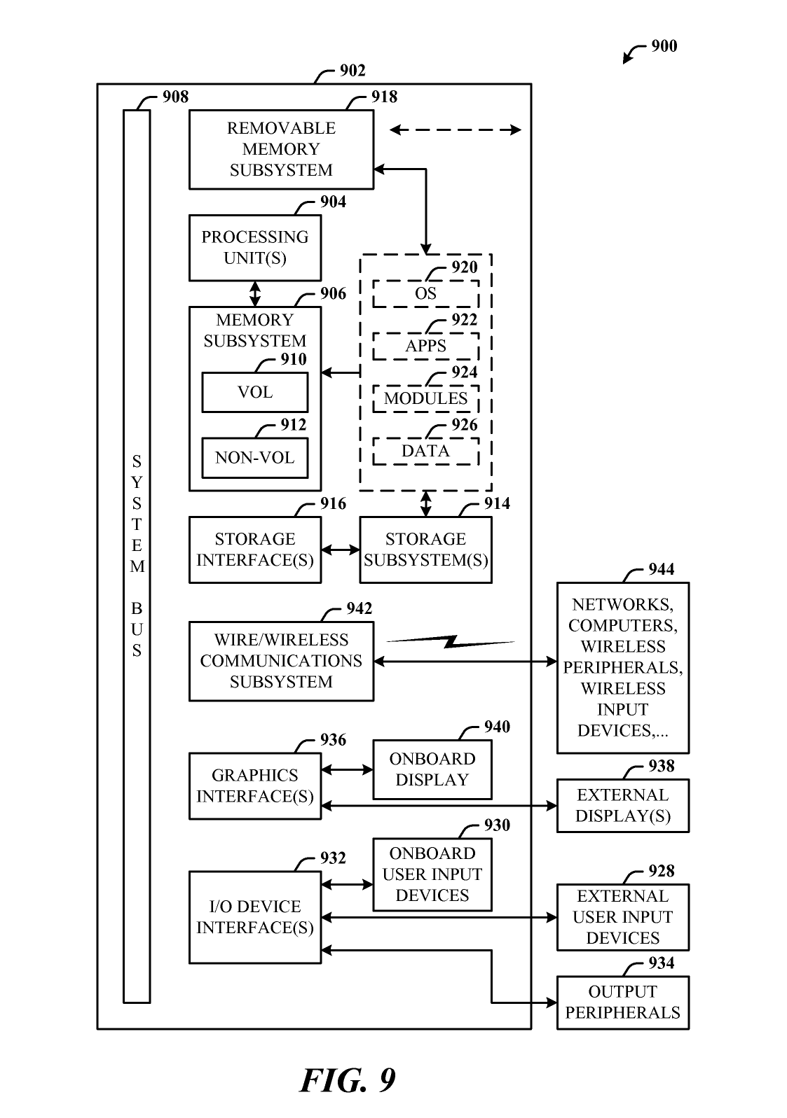

Referring now to FIG. 9, there is illustrated a block diagram of a computing system 900 that facilitates the return of orthogonal dimensions in search to encourage user exploration in accordance with the disclosed architecture. However, it is appreciated that the some or all aspects of the disclosed methods and/or systems can be implemented as a system-on-a-chip, where analog, digital, mixed signals, and other functions are fabricated on a single chip substrate.

In order to provide additional context for various aspects thereof, FIG. 9 and the following description are intended to provide a brief, general description of the suitable computing system 900 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 900 for implementing various aspects includes the computer 902 having processing unit(s) 904 (also referred to as microprocessor(s) and processor(s)), a computer-readable storage medium such as a system memory 906 (computer readable storage medium/media also include magnetic disks, optical disks, solid state drives, external memory systems, and flash memory drives), and a system bus 908. The processing unit(s) 904 can be any of various commercially available processors such as single-processor, multi-processor, single-core units and multi-core units of processing and/or storage circuits. Moreover, those skilled in the art will appreciate that the novel methods can be practiced with other computer system configurations, including minicomputers, mainframe computers, as well as personal computers (e.g., desktop, laptop, tablet PC, etc.), hand-held computing devices, microprocessor-based or programmable consumer electronics, and the like, each of which can be operatively coupled to one or more associated devices.

The computer 902 can be one of several computers employed in a datacenter and/or computing resources (hardware and/or software) in support of cloud computing services for portable and/or mobile computing systems such as cellular telephones and other mobile-capable devices. Cloud computing services, include, but are not limited to, infrastructure as a service, platform as a service, software as a service, storage as a service, desktop as a service, data as a service, security as a service, and APIs (application program interfaces) as a service, for example.

The system memory 906 can include computer-readable storage (physical storage) medium such as a volatile (VOL) memory 910 (e.g., random access memory (RAM)) and a non-volatile memory (NON-VOL) 912 (e.g., ROM, EPROM, EEPROM, etc.). A basic input/output system (BIOS) can be stored in the non-volatile memory 912, and includes the basic routines that facilitate the communication of data and signals between components within the computer 902, such as during startup. The volatile memory 910 can also include a high-speed RAM such as static RAM for caching data.

The system bus 908 provides an interface for system components including, but not limited to, the system memory 906 to the processing unit(s) 904. The system bus 908 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 902 further includes machine readable storage subsystem(s) 914 and storage interface(s) 916 for interfacing the storage subsystem(s) 914 to the system bus 908 and other desired computer components and circuits. The storage subsystem(s) 914 (physical storage media) can include one or more of a hard disk drive (HDD), a magnetic floppy disk drive (FDD), solid state drive (SSD), and/or optical disk storage drive (e.g., a CD-ROM drive DVD drive), for example. The storage interface(s) 916 can include interface technologies such as EIDE, ATA, SATA, and IEEE 1394, for example.

One or more programs and data can be stored in the memory subsystem 906, a machine readable and removable memory subsystem 918 (e.g., flash drive form factor technology), and/or the storage subsystem(s) 914 (e.g., optical, magnetic, solid state), including an operating system 920, one or more application programs 922, other program modules 924, and program data 926.

The operating system 920, one or more application programs 922, other program modules 924, and/or program data 926 can include entities and components of the system 100 of FIG. 1, entities and components of the system 200 of FIG. 2, entities and components of the backend system diagram 300 of FIG. 3, items and parts of the results page 400 of FIG. 4, items and parts of the results page 500 of FIG. 5, items and parts of the results page 600 of FIG. 6, and the methods represented by the flowcharts of FIGS. 7 and 8, for example.

Generally, programs include routines, methods, data structures, other software components, etc., that perform particular tasks or implement particular abstract data types. All or portions of the operating system 920, applications 922, modules 924, and/or data 926 can also be cached in memory such as the volatile memory 910, for example. It is to be appreciated that the disclosed architecture can be implemented with various commercially available operating systems or combinations of operating systems (e.g., as virtual machines).

The storage subsystem(s) 914 and memory subsystems (906 and 918) serve as computer readable media for volatile and non-volatile storage of data, data structures, computer-executable instructions, and so on. Such instructions, when executed by a computer or other machine, can cause the computer or other machine to perform one or more acts of a method. Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. The instructions to perform the acts can be stored on one medium, or could be stored across multiple media, so that the instructions appear collectively on the one or more computer-readable storage medium/media, regardless of whether all of the instructions are on the same media.

Computer readable storage media (medium) exclude (excludes) propagated signals per se, can be accessed by the computer 902, and include volatile and non-volatile internal and/or external media that is removable and/or non-removable. For the computer 902, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

A user can interact with the computer 902, programs, and data using external user input devices 928 such as a keyboard and a mouse, as well as by voice commands facilitated by speech recognition. Other external user input devices 928 can include a microphone, an IR (infrared) remote control, a joystick, a game pad, camera recognition systems, a stylus pen, touch screen, gesture systems (e.g., eye movement, head movement, etc.), and/or the like. The user can interact with the computer 902, programs, and data using onboard user input devices 930 such a touchpad, microphone, keyboard, etc., where the computer 902 is a portable computer, for example.

These and other input devices are connected to the processing unit(s) 904 through input/output (I/O) device interface(s) 932 via the system bus 908, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 932 also facilitate the use of output peripherals 934 such as printers, audio devices, camera devices, and so on, such as a sound card and/or onboard audio processing capability.

One or more graphics interface(s) 936 (also commonly referred to as a graphics processing unit (GPU)) provide graphics and video signals between the computer 902 and external display(s) 938 (e.g., LCD, plasma) and/or onboard displays 940 (e.g., for portable computer). The graphics interface(s) 936 can also be manufactured as part of the computer system board.

The computer 902 can operate in a networked environment (e.g., IP-based) using logical connections via a wired/wireless communications subsystem 942 to one or more networks and/or other computers. The other computers can include workstations, servers, routers, personal computers, microprocessor-based entertainment appliances, peer devices or other common network nodes, and typically include many or all of the elements described relative to the computer 902. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 902 connects to the network via a wired/wireless communication subsystem 942 (e.g., a network interface adapter, onboard transceiver subsystem, etc.) to communicate with wired/wireless networks, wired/wireless printers, wired/wireless input devices 944, and so on. The computer 902 can include a modem or other means for establishing communications over the network. In a networked environment, programs and data relative to the computer 902 can be stored in the remote memory/storage device, as is associated with a distributed system. It will be appreciated that the network connections shown are exemplary and other means of establishing a communications link between the computers can be used.

The computer 902 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related technology and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
an intent component that computes original intent and a primary result document of a domain of a primary search query, and identifies orthogonal intent of the primary search query based on orthogonal intent information;
a search component that generates and returns an alternative result document of at least one of the domain or another domain for presentation based on the orthogonal intent; and
at least one microprocessor circuit that executes computer-executable instructions in a memory associated with each of the intent component and the search component.

2. The system of claim 1, wherein the alternative result document relates to trending content of the domain or other domains.

3. The system of claim 1, wherein the orthogonal intent is computed based on the orthogonal intent information derived from analysis of user interaction with content of the domain.

4. The system of claim 1, further comprising a content component that computes trending content of the domain based on trending topics, social data, and browser data.

5. The system of claim 1, further comprising a content component that computes navigational content related to social data, search data, and trending topics.

6. The system of claim 1, further comprising a website profile component that generates a website profile based in part on classification of website user-accessed documents and document content.

7. The system of claim 6, wherein the website profile component periodically updates the website profile.

8. The system of claim 1, further comprising a ranking component that ranks website documents based in part on a website profile and category of the original intent.

9. A method, comprising acts of:
computing intent of a search query;
identifying a target document result of a domain based on the query intent;
generating an alternative document result of the domain related to the intent;
presenting content associated with the alternative document result; and
configuring a microprocessor circuit that executes instructions in a memory related to the acts of computing, identifying, generating, and presenting.

10. The method of claim 9, further comprising computing a category of the query based on the intent.

11. The method of claim 9, further comprising computing the content based on personalized data.

12. The method of claim 9, further comprising computing the content based on anonymized data.

13. The method of claim 9, further comprising creating a website profile on which to base the alternative document result.

14. The method of claim 9, further comprising selecting the content to present based on candidate content ranked according to category and website profile information.

15. A computer-readable medium comprising computer-executable instructions that when executed by a microprocessor, cause the microprocessor to perform acts of:
computing orthogonal intent based on original intent of a query, the original intent related to a domain;
generating alternative search results of the domain based on the orthogonal intent;
presenting the alternative results on the search results page; and
configuring a microprocessor circuit that executes instructions in a memory related to the acts of computing, generating, and presenting.

16. The computer-readable medium of claim 15, further comprising computing the content based on personalized data or anonymized data.

17. The computer-readable medium of claim 15, further comprising selecting the content to be presented based on content ranked according to category and website profile information.

18. The computer-readable medium of claim 15, further comprising computing the orthogonal intent based on user interaction with content of a landing page.

19. The computer-readable medium of claim 15, further comprising computing the alternative search results based on offline pipelines for generating trending topics, trending content, search content, and social network data.

20. The computer-readable medium of claim 15, further comprising presenting the alternative results as in a listing of the search results.
